(19) United States
(12) Patent Application Publication
(10) Pub. No.: US 2006/0256834 A1
(43) Pub. Date: Nov. 16, 2006

(54) METHOD AND APPARATUS FOR CONDUCTING PERFORMANCE TEST TO HEAT PIPE

(76) Inventors: Chang-Shen Chang, Shenzhen (CN); Cheng-Hui Lin, Shenzhen (CN); Teng-Tsung Huang, Shenzhen (CN); Fei Han, Shenzhen (CN); Zheng Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,588

(22) Filed: Feb. 14, 2006

(30) Foreign Application Priority Data
May 14, 2005 (CN) 200510034683.3

(51) Int. Cl. G01N 25/72

(52) U.S. Cl. 374/5

(57) ABSTRACT

Disclosed is a method for testing the performance of a heat pipe and an apparatus for conducting the performance test. The apparatus includes a heating device and a cooling device. Two ends of the heat pipe are thermally connected to the heating device and the cooling device, respectively. The heating device is applied to supply thermal energy to the heat pipe. When the quantity of thermal energy being transferred to the heat pipe reaches to a specified value, the temperatures at the two ends of the heat pipe are detected. If the temperature difference between the two ends is lower than a predetermined value, the heat pipe being tested is deemed as acceptable.

### FIELD OF THE INVENTION

The present invention relates to a method for testing the performance of a heat pipe so as to find whether or not the heat pipe being tested is acceptable to a specific cooling requirement. The present invention also relates to an apparatus for conducting the performance test.

### DESCRIPTION OF RELATED ART

As scientific technology continues to advance in electronic industry, a variety of electronic components such as central processing units (CPUs) of computers are currently suffering serious heat-dissipating problem with which conventional heat dissipation devices, for example, heat sinks and fans, are difficult to deal. Now, in order to solve this problem, heat pipes are often incorporated into these conventional heat dissipation devices so as to dissipate heat from the electronic components more rapidly and effectively. Heat pipes have excellent heat transfer performance due to their low thermal resistance, thus providing an effective means for overcoming overheating problem of advanced electronic components.

A heat pipe is usually a vacuum vessel which defines therein a chamber for containing a working fluid such as water. The working fluid is employed to carry heat from one end of the heat pipe, typically referred to as “evaporating section”, to the other end of the heat pipe, typically referred to as “condensing section”. Preferably, a wick structure, such as mesh or sintered powder, is provided in the chamber, lining the inside walls of the vessel. In application, conventional heat dissipation devices such as fins are coupled to the condensing section of the heat pipe to thereby form a cooling assembly. As the evaporating section of the heat pipe is maintained in thermal contact with a heat-generating component, heat is absorbed in the evaporating section and the working fluid contained therein evaporates into vapor. The vapor moves towards the condensing section of the heat pipe under the vapor pressure gradient between the two sections. In the condensing section, the vapor releases its latent heat to atmosphere environment by the fins, and then is condensed into liquid. The condensed liquid then returns back to the evaporating section rapidly via capillary action provided by the wick structure. Thus, the heat generated by the heat-generating component is removed.

In order to ensure that the heat is rapidly and effectively removed from the heat-generating component, the heat pipe is generally required to be tested before sent for application in order to find whether or not its performance satisfies the cooling requirement of the heat-generating component. The thermal resistance (Rth), the maximum heat transfer capacity (Qmax) and the temperature difference (ΔT) between two ends are three parameters that are commonly used to evaluate the performance of a heat pipe. The relationship between these parameters Qmax, Rth and ΔT is Rth=ΔT/Qmax. As a competent heat pipe to the heat-generating component, the general rule is that its thermal resistance Rth and temperature difference ΔT between its two ends should be as low as possible and its maximum heat transfer capacity Qmax should be higher than the thermal design power of the heat-generating component, if only one heat pipe is used in the cooling assembly.

FIG. 3 shows a conventional method for testing the performance of a heat pipe 1. The heat pipe 1 is partially inserted into a constant temperature water bath 2 containing hot water. After a specified time period, the respective temperatures T1, T2 at two ends of the heat pipe 1 are detected, and if the temperature difference ΔT between the two ends is lower than a predetermined value, fox example, 1 degree centigrade, the heat pipe 1 being tested will be deemed as acceptable to the heat-generating component. However, this method cannot obtain the quantity of heat actually transferred from the hot water to the heat pipe 1. Thus, on some occasions, it may lead that for some heat pipes their maximum heat transfer capacity is lower than the thermal design power of the heat-generating component, but they are judged as acceptable to the heat-generating component through this method.

In view of the above-mentioned disadvantage of the conventional art, there is a need for a method which can be applied to evaluate the performance of a heat pipe more accurately. What is also needed is an apparatus for conducting the performance test to the heat pipe.

### SUMMARY OF INVENTION

The present invention in one aspect, relates to a method for testing the performance of a heat pipe. A preferred method includes the following steps: (1) providing a heating device and a cooling device, and putting a first end and a second end of the heat pipe to thermally contact with the heating device and the cooling device, respectively; (2) using the heating device to transfer thermal energy to the heat pipe and using the cooling device to remove the thermal energy from the heat pipe in order to maintain the heat pipe in working condition; (3) detecting the temperature difference between the first and second ends of the heat pipe when the quantity of thermal energy transferred to the heat pipe reaches to a specified value; (4) judging whether or not the heat pipe is acceptable according to the value of the temperature difference.

The present invention in another aspect, relates to an apparatus for conducting the performance test to the heat pipe. In a preferred embodiment, the apparatus includes a heating device, a cooling device, an electronic module, a first temperature detector and a second temperature detector. The heating device is thermally connected with a first end of the heat pipe for transferring thermal energy to the heat pipe. The cooling device is thermally connected with a second end of the heat pipe for removing the thermal energy from the heat pipe after the thermal energy is transferred from the first end to the second end. The first temperature detector is applied to detect the respective temperatures at three spaced points selected from the heating device. The second temperature detector is applied to detect the temperatures at the first and second ends of the heat pipe. The electronic module is connected with the first temperature detector to receive the numerical values of the temperatures of the three points.

Other advantages and novel features of the present invention will become more apparent from the following detailed description of preferred embodiments when taken in conjunction with the accompanying drawings, in which:

### BRIEF DESCRIPTION OF DRAWINGS

FIG. 1 is a flow chart showing the main steps of a preferred method of the present invention, for testing the performance of a heat pipe;

FIG. 2 is a schematic view of an apparatus in accordance with one embodiment of the present invention, for conducting the performance test to heat pipe by applying the preferred method of FIG. 1; and

FIG. 3 is a schematic view showing a method for testing the performance of a heat pipe in accordance with the conventional art.

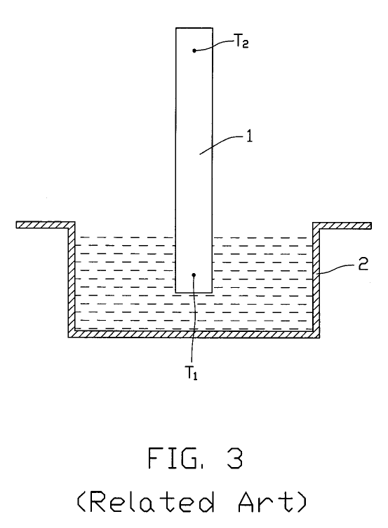

### DETAILED DESCRIPTION

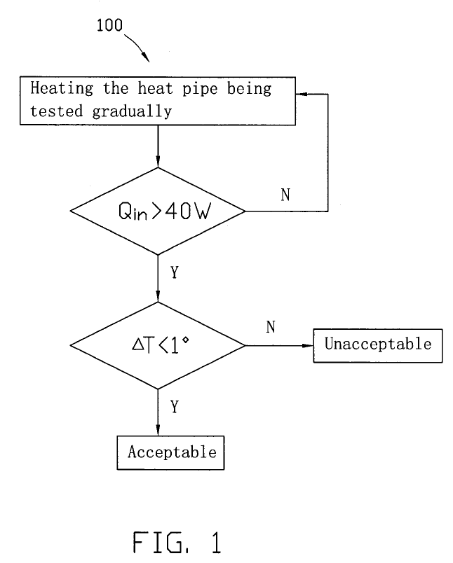

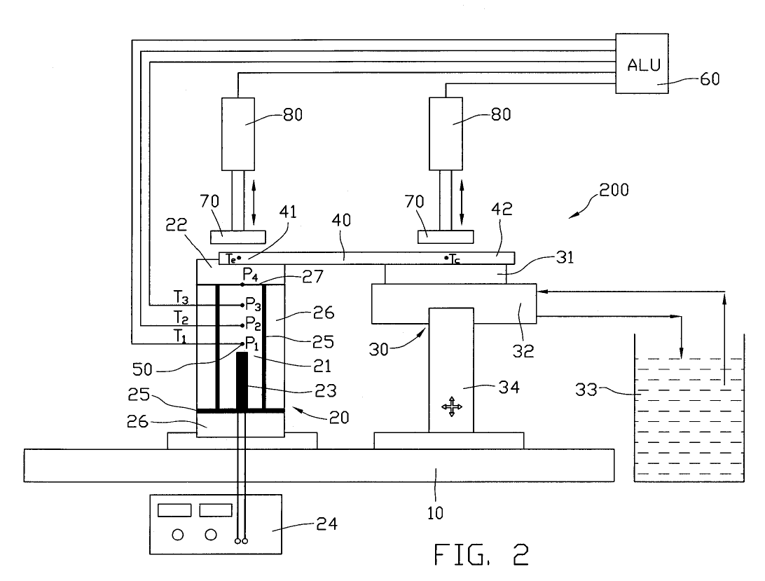

FIG. 1 is a flow chart showing the main steps of a preferred method 100 of the present invention for testing the performance of a heat pipe 40 (see FIG. 2). This method 100 is directed to obtain two parameters, i.e., Qin and ΔT, from the heat pipe 40. The first parameter Qin is the quantity of heat energy transferred to the heat pipe 40. The first parameter Qin is typically used to reflect the heat transfer capacity of the heat pipe 40. The second parameter ΔT is the temperature difference between two ends of the heat pipe 40. Firstly, the heat pipe 40 is heated gradually until the heat pipe 40 begins to work. Then, the first parameter Qin is obtained, and if it exceeds a first value, a following procedure is commenced to obtain the second parameter ΔT. If the obtained parameter ΔT is lower than a second value, the heat pipe 40 being tested will be deemed as acceptable. The selection of the first and second values is based on a case-by-case basis. For example, the first and second values may be determined according to the cooling requirement of a specific heat-generating component to which the heat pipe 40 is applied to remove heat therefrom. In this case, it is assumed that, as a competent heat pipe, the first parameter Qin of the heat pipe 40 should be higher than a value of 40 watts and the second parameter ΔT should be lower than a value of 1 degree centigrade. Through this method 100, those heat pipes with their maximum heat transfer capacity being lower than 40 watts will not be accepted, thereby overcoming the disadvantage of the conventional test method depending only on ΔT.

FIG. 2 schematically illustrates an apparatus 200 for conducting the performance test to the heat pipe 40 by applying the method 100. The apparatus 200 includes a supporting base 10, a heating device 20 and a cooling device 30. The heating device 20 and the cooling device 30 are mounted on the supporting base 10 and are spaced from each other.

The heating device 20 includes a heat-transferring block 21, a heating block 22 located above and thermally connected with the heat-transferring block 21 and an electric heater 23 completely received in a lower portion of the heat-transferring block 21. The electric heater 23 is inserted into the heat-transferring block 21 along a longitudinal direction thereof. The heat-transferring block 21 and heating block 22 may be integrally formed, and preferably, the heating block 22 has a larger cross-sectional area than the heat-transferring block 21. The heat-transferring block 21 and heating block 22 are preferably made of copper or other materials with excellent thermal conductivity. The electric heater 23 is connected with a direct-current power supply 24 so as to supply thermal energy to the heat-transferring block 21. The thermal energy supplied by the electric heater 23 is then transferred upwardly from the heat-transferring block 21 along its longitudinal direction to the heating block 22, and is further transferred to the heat pipe 40 from the heating block 22. In order to prevent the thermal energy supplied by the electric heater 23 from dissipating into ambient environment, first and second heat insulation layers 25, 26 are provided to surround the heat-transferring block 21. The heat insulation layers 25, 26 are made of heat-insulating materials such as fiber glass, Bakelite or asbestos. Thus, the thermal energy supplied by the electric heater 23 is generally considered be fully transferred to the heating block 22 from the heat-transferring block 21.

The cooling device 30 includes a cooling block 31, a cooling jacket 32 and a low temperature water tank 33. The cooling jacket 32 is located below and thermally connected with the cooling block 31. The cooling device 30 employs water circulating through the cooling jacket 32 to thereby remove heat from the cooling block 31 which is in thermal contact with the heat pipe 40. Preferably, an adjustment mechanism 34 is provided between the cooling jacket 32 and the supporting base 10 to adjust the positions of the cooling jacket 32 and the cooling block 31 so that the apparatus 200 can be suitably applied to test heat pipes with different lengths or configurations.

Before the performance test to the heat pipe 40 is conducted, two ends of the heat pipe 40, i.e., the evaporating section 41 and the condensing section 42, are placed to thermally contact with the heating block 22 and the cooling block 31, respectively. Preferably, the evaporating section 41 is arranged to be partially or fully received in the heating block 22 from a top surface thereof so as to increase the contact surface between the heating block 22 and the heat pipe 40.

Then, the supply power 24 is controlled to gradually supply thermal energy to the heat-transferring block 21 via the electric heater 23. Meanwhile, at least one temperature detector 50 is used to detect the respective temperatures T1, T2, T3 at three spaced points P1, P2, P3 selected from an upper portion of the heat-transferring block 21. The three points P1, P2, P3 are linearly located between the heating block 22 and the electric heater 23 along the longitudinal direction of the heat-transferring block 21. The temperature detector 50 may be a thermal couple or a thermometer to be connected with a corresponding point P1, P2 or P3. For example, three thermal couples may simultaneously be used to measure the temperatures T1, T2, T3 of the three points P1, P2, P3, respectively. The temperature detector 50 is electrically connected with an electronic module 60 such as an Arithmetic/Logic Unit (ALU) or a central processing unit (CPU) of a computer, so that the numerical values of the temperatures T1, T2, T3 can be inputted into the electronic module 60 for calculations. As the thermal energy supplied by the electric heater 23 is generally considered be fully transferred to the heating block 22, thus, at a given time point, the temperature distribution in the upper portion of the heat-transferring block 21 can be shown in the following relationship:
T(x)=a*x2+b*x+c (1)

Where x represents the distance between the electric heater 23 and a point selected from the upper portion of the heat-transferring block 21, T(x) represents the temperature value of the selected point, and a, b and c are constants at the given time point.

From Equation (1), the quantity of thermal energy transferred through a horizontal cross-sectional surface of the upper portion of the heat-transferring block 21 at the given time point can therefore be described as follows:
Q(x)=k*A*dT(x)/dx=k*A*(2*a*x+b) (2)

Where k is the heat transfer coefficient of the heat-transferring block 21, A is the surface area of the horizontal cross-sectional surface, and Q(x) represents the quantity of thermal energy transferred through the horizontal cross-sectional surface at the given time point. Both the coefficient k and the surface area A are constants.

If the distances x1, x2, x3 between each of the three points P1, P2, P3 and the electric heater 23 and the corresponding temperatures T1, T2, T3 of the three points P1, P2, P3 are respectively introduced into Equation (1), the numerical values of the constants a, b, c at this given time point can be accordingly determined. After the constants a, b, c are determined, the temperature Tcase at a fourth point P4 selected from a top surface 27 of the heat-transferring block 21, i.e., the contacting surface between the heating block 22 and the heat-transferring block 21, can easily be obtained at this given time point by introducing the distance Xcase, i.e., the distance between the contacting surface and the electric heater 23, into Equation (1). Similarly, the quantity of thermal energy Qcase transferred through the contacting surface from the heat-transferring block 21 to the heating block 22 at this given time point also can be easily obtained by introducing the distance Xcase into Equation (2). In this embodiment, all of the resulting data, including a, b, c, Tcase and Qcase, are obtained from the electronic module 60 by calculation based on the original data including T1, T2, T3, x1, x2, x3, Xcase, k and A.

Because the heating block 22 has excellent thermal conductivity, the temperature at the contacting interface between the heat pipe 40 and the heating block 22 is very close to the temperature Tcase. Thus, if the temperature Tcase obtained from the electronic module 60 is lower than the working temperature of the heat pipe 40, the heat pipe 40 generally will not begin to work. For easy understanding, it is assumed that the working temperature of the heat pipe 40 is at 60 degrees centigrade. Within a short time period from the beginning of the performance test, the temperature Tcase generally is lower than 60 degrees centigrade because the thermal energy supplied by the electric heater 23 is fully applied to heat the heat-transferring block 21 and the heating block 22. As the power supply 24 is controlled to continue to supply thermal energy to the heat device 20 via the electric heater 23, the numerical value of the temperature Tcase will gradually increase. When the temperature Tcase obtained by the electronic module 60 at a later time point reaches to 60 degrees centigrade, from then on, the heat pipe 40 will begin to work since the heat pipe 40 will also reaches to 60 degrees centigrade, i.e., its working temperature. That is, the working fluid contained in the evaporating section 41 of the heat pipe 40 will begin to evaporate into vapor. The generated vapor then moves to the condensing section 42 where the vapor releases its latent heat to the cooling device 30 and is condensed into liquid. The condensed liquid then returns back to the evaporating section 41 via wick structure that is provided in the heat pipe 40. Thus, from then on, a portion of the thermal energy transferred to the heating block 22 will be transferred to the evaporating section 41 of the heat pipe 40, and further is transferred by the heat pipe 40 to the condensing section 42. At this time, the cooling device 30 is controlled to remove the portion of thermal energy away from the condensing section 42, thereby maintaining the heat pipe 40 in working condition.

As the power supply 24 is further controlled to input thermal energy to the heating device 20 in an increasing manner, the portion of thermal energy transferred by the heat pipe 40 will gradually increase in amount so long as the quantity of thermal energy transferred to the heat pipe 40 is under the maximum heat transfer capacity of the heat pipe 40. Thus, the temperature of the heating block 22 is basically maintained at 60 degrees centigrade since the heat pipe 40 is still maintained in working condition. Consequently, the quantity of thermal energy transferred to the heat pipe 40, i.e., the parameter Qin, can therefore be easily determined from the following equation:
Qin=Qcase−Q′ (3)

Where Qcase is the quantity of thermal energy transferred through the top surface 27 at a given time point, and Q′ is the quantity of thermal energy dissipated into ambient environment by the heating block 22 at 60 degrees centigrade.

The value of Qcase at the given time point can be obtained from the foregoing equations (1) and (2) by following the above-mentioned steps. The value of Q′ can be determined by using a heater to heat the heating block 22 gradually until the heating block 22 reaches to 60 degrees centigrade and establishes thermal equilibrium with ambient environment. When the parameters Q′ and Qcase are introduced into Equation (3), the parameter Qin at this given time point is therefore obtained. If the value of Qin obtained at this time point is lower than 40 watts, thermal energy is continued be transferred to the heating device 20 by the supply power 24 and the electric heater 23. When, at a later time point, the value of Qin obtained reaches to 40 watts, a pair of temperature detectors 70 which is electrically connected with the electronic module, is applied to detect the temperatures Te, Tc at the two ends of the heat pipe 40. Each of the temperature detectors 70 can move freely in a vertical direction and is driven by a pneumatic cylinder 80 which is controlled by the electronic module 60. That is, after the value of Qin obtained from the electronic module 60 reaches to 40 watts, the temperature detectors 70 are released downwardly from the pneumatic cylinders 80 to approach and contact with the heat pipe 40 for detecting the temperatures Te, Tc. If the temperature difference ΔT between the two ends of the heat pipe 40 is lower than 1 degree centigrade, the heat pipe 40 being tested will be deemed as acceptable. On the contrary, the heat pipe 40 will be deemed as unacceptable.

In accordance with the present invention, the performance test to the heat pipe 40 can be finished in a short time period, only about 90 seconds. In addition, if the maximum heat transfer capacity of a heat pipe is lower than 40 watts, the heat pipe will not be passed as acceptable through this method 100, thereby increasing accuracy to the performance test. We take a heat pipe with a maximum heat transfer capacity of 35 watts for example. When the value of Qin obtained from Equation (3) at a time point reaches to 35 watts, after this time point, the temperature of the heating block 22 will begin to rise, since additional thermal energy is continued to be supplied to the heating block 22 by the electric heater 23 and this portion of additional thermal energy cannot further be removed by the heat pipe 40 because the heat pipe 40 has reached to its maximum heat transfer capacity. Accordingly, the temperature at the evaporating section of the heat pipe will also begin to rise and as a result, the subsequently obtained parameter ΔT, i.e., the temperature difference between two ends of the heat pipe, will exceed 1 degree centigrade. Therefore, those heat pipes with maximum heat transfer capacity lower than 40 watts will not pass the test to be deemed as an acceptable heat pipe.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for testing performance of a heat pipe comprising steps of:
providing a heating device and a cooling device, and putting a first end and a second end of the heat pipe to thermally contact with the heating device and the cooling device, respectively;
using the heating device to transfer thermal energy to the heat pipe and using the cooling device to remove the thermal energy from the heat pipe in order to maintain the heat pipe in working condition;
detecting the temperature difference between the first and second ends of the heat pipe when the quantity of thermal energy transferred to the heat pipe reaches to a specified value; and
judging whether or not the heat pipe is acceptable according to the value of the temperature difference.

2. The method of claim 1, wherein the heating device comprises a heat-transferring block, a heating block thermally connected with the heat-transferring block and a heater inserted into the heat-transferring block, wherein the heat pipe is connected with the heating block and the heater supplies thermal energy to the heating block via the heat-transferring block.

3. The method of claim 2, wherein the quantity of thermal energy transferred to the heat pipe, Qin, is obtained from the following equation Qin=Qcase−Q′; where Qcase is the quantity of thermal energy transferred from the heat-transferring block along a heat transfer direction thereof to the heating block, and Q′ is the quantity of thermal energy dissipated into ambient environment by the heating block at a working temperature of the heat pipe, the heat pipe starting to function when the first end of the heat pipe reaches the working temperature.

4. The method of claim 3, further comprising the step of detecting the respective temperatures at three spaced points selected from the heat-transferring block, and the value of Qcase is obtained by calculation based on the values of the temperatures of the three points.

5. The method of claim 4, wherein the three points are linearly arranged along the heat transfer direction of the heat-transferring block between the heating block and the heater.

6. The method of claim 1, wherein in the judging step, if the value of the temperature difference is lower than a predetermined value, the heat pipe is deemed as acceptable, and if on the contrary, the heat pipe is deemed as unacceptable.

7. An apparatus for conducting performance test to a heat pipe, the apparatus comprising:
a heating device adapted for thermally connecting with a first end of the heat pipe to transfer thermal energy to the heat pipe;
a cooling device adapted for thermally connecting with a second end of the heat pipe to remove the thermal energy from the heat pipe after the thermal energy is transferred from the first end to the second end;
first temperature detector for detecting the respective temperatures at three spaced points selected from the heating device and second temperature detector for detecting the temperatures at the first and second ends of the heat pipe; and
an electronic module electrically connected with the first temperature detector to receive the numerical values of the temperatures of the three points.

8. The apparatus of claim 7, wherein the heating device comprises a heat-transferring block, a heating block located above and thermally connected with the heat-transferring block and a heater inserted into the heat-transferring block, wherein the heat pipe is connected with the heating block and the heater supplies thermal energy to the heat-transferring block.

9. The apparatus of claim 8, wherein the three points are selected from the heat-transferring block and are linearly located between the heating block and the heater.

10. The apparatus of claim 8, wherein the heating block and the heat-transferring block are two portions of an integral body.

11. The apparatus of claim 8, wherein the heat-transferring block is surrounded by heat insulation material.

12. The apparatus of claim 7, wherein the second temperature detector is electrically connected with the electronic module and is movable with respect to said heat pipe.

13. The apparatus of claim 7, wherein the cooling device further comprises an adjustment mechanism to regulate the position of the cooling device.

14. A method for determining acceptance of a heat pipe by an apparatus, the heat pipe having an evaporating section and a condensing section, the method comprising the following steps:
a) providing thermal energy to the evaporating section and determining whether a quantity of energy transferred by the heat pipe from the evaporating section to the condensing section has reached a predetermined amount, if yes the heat pipe is subjected to following step; and
b) determining whether a temperature difference between the evaporating section and the condensing section has exceeded a predetermined value, if yes, the heat pipe is rejected, if no the heat pipe is accepted.

15. The method of claim 14, wherein the thermal energy provided to the evaporating section is supplied by a heating device of the apparatus, the heating device including a heater, a heating block in thermal contact with the evaporating section of the heat pipe and a heat transferring block between the heater and the heating block, the heat transferring block transferring heat generated by the heater to the heating block, temperatures of three points of the heat transferring block are measured in order to determine whether the quantity of energy transferred by the heat pipe from the evaporating section to the condensing section has reached the predetermined amount.

16. The method of claim 15, wherein two moveable temperature detectors are used to determine whether the temperature difference between the evaporating section and the condensing section has exceeded the predetermined value.

17. The method of claim 16, wherein the condensing section thermally contacts with a fluid, which takes away the energy transferred by the heat pipe from the evaporating section to the condensing section.

18. The method of claim 17, wherein the heat transferring block is surrounded by a heat-insulating material.

19. The method of claim 18, wherein the condensing section thermally contacts with a cooling jack through which the fluid flows, position of the cooling jack being adjustable.

20. The method of claim 19, wherein the two movable temperature detectors are mounted on two fluid-driving cylinders, respectively.
